(19) United States
(12) Patent Application Publication
(10) Pub. No.: US 2011/0271596 A1
(43) Pub. Date: Nov. 10, 2011

(54) DRIVE SYSTEM FOR A DOOR

(75) Inventor: Gerd Schaaf, Kirchheim/Teck (DE)

(73) Assignee: SOMMER ANTRIEBS-UND FUNKTECHNIK GMBH

(21) Appl. No.: 13/145,595

(22) PCT Filed: Jan. 9, 2010
(86) PCT No.: PCT/EP10/00066

§ 371 Date: Jul. 21, 2011

(30) Foreign Application Priority Data
Jan. 24, 2009 (DE) 20 2009 000 929.7

(51) Int. Cl. E05F 15/02

(52) U.S. Cl. 49/358

(57) ABSTRACT

A drive system for a door having a door leaf guided laterally in guide rails. A carriage, which is connected to the upper edge of the door leaf in an articulated manner, is arranged to be guided along one of the guide rails. Conductive tracks running along the guide rail are provided for supplying power to a motor driving the carriage. The conductive tracks can optionally be contacted at the front or back ends thereof.

### CROSS-REFERENCE TO RELATED APPLICATIONS

This application is a U.S. National Stage Application of PCT/EP2010/000066, filed Jan. 9, 2010, which designates the United States and claims the priority of German Patent Application No. 20 2009 000 929, filed on Jan. 24, 2009.

### BACKGROUND

1. Field of Invention

The invention relates to a drive system for a door. In particular, the door for which this drive system is used can be a garage door.

2. Related Art

A drive system of this type is already known from the document DE 10 2008 004 050.

The aforementioned drive system is used to open and close a door provided with a door leaf which is guided inside a guide rail on each respective side. A carriage traverses inside one of the guide rails while a push arm is connected articulated to the carriage as well as to the upper edge of the door leaf. A motor is positioned on this push arm.

The drive system is embodied as a chain drive with a chain wheel positioned on a motor shaft, wherein this chain wheel engages during the operation of the drive system in a chain that moves along the guide rail.

Power is supplied to the motor via a conductive rail with therein disposed electrical lines. The conductive rail is embodied integrally with the chain channel.

### SUMMARY

It is an object of the present invention to increase the functionality of a drive system of the type as described in the above.

An embodiment of the invention relates to a drive system for a door, provided with a door leaf which is guided in a guide rail on each respective side. A carriage is connected articulated to the upper edge of the door leaf and traverses along one of the guide rails. Conductive tracks that extend along the guide rails are provided for supplying power to a motor which drives the carriage, wherein these conductive tracks can optionally be contacted either at the front or the back end thereof.

The drive system according to an embodiment of the invention can be installed quickly and without high design expenditure on differently designed door systems. It is particularly advantageous that one of the guide rails for the door can also be used for guiding the carriage, wherein the movement of this carriage causes the opening and closing of the door. The fact that the carriage can be installed optionally on either one of the guide rails is also advantageous and further increases the flexibility for installing the drive system.

In an embodiment of the drive system according to the invention, the conductive tracks can optionally be contacted either at the front end or at the back end thereof, thus making it possible to keep the lines short which are used for supplying power to the conductive tracks.

According to another embodiment of the invention, a different rail that extends along the guide rail is provided for accommodating two metal inserts which form the conductive tracks extending along the longitudinal axis.

The rail containing the metal inserts forms a modular element which can be installed on different types of guide rails. Since the metal inserts are integrated into the rail, they are completely independent of the electrical properties of the guide rail. It is furthermore advantageous that the rail itself, or units which can be installed thereon, ensure the secure positioning of the metal inserts, so that no additional structural measures are required.

In another embodiment, the rail has a C-shaped profile for accommodating the conductive tracks, wherein the metal inserts are separated mechanically and electrically by a web in the rail.

As a result, a structurally extremely simple fastening and electrical separation of the metal inserts is possible.

According to yet another embodiment of the invention, a separate contacting module for the electrical contacting of the metal inserts can be installed on the front as well as the back end of the rail, wherein a plug can optionally be inserted into one or the other of the contacting modules for creating the electrical connection.

The contacting via the plug is especially easy and, in particular, does not require the use of any tools.

The contacting modules in the form of modular units can be installed so as to be replaceable on the rail. The contacting module can thus be installed at the front as well as the back end of the rail. The contacting modules may ensure the mechanical fastening of the metal inserts in the rail. The contacting modules can be embodied identical or can have different structural forms.

According to still another embodiment, the rail meets a number of additional functions.

Modules that are provided with actuators for the limit switches integrated into the carriage can thus be arranged so as to be displaceable on the rail.

The rail is furthermore pressed against an end stop inside the carriage, wherein this end stop is composed of a material with sliding ability. The rail supports a controlled guidance of the traction means, that is to say the chain. With this type of design, it is furthermore achieved that the forces generated by the chain wheel remain within the carriage and do not escape, owing to the fact that the rail is supported against the end stop.

The rail embodied in this way forms a highly integrated component which itself takes over several different functions of the drive system and to which different modules of the drive system can be adapted.

The fact that a traction means is integrated into the rail, along which the carriage can be moved, further increases the functionality of the rail.

The traction means can generally be embodied as a toothed belt, a perforated belt, a rope, a ball chain or as a toothed rack which engages in a drive element for the carriage.

In particular, a chain inserted into the rail may be used for the guiding means, wherein a chain wheel driven by the motor engages in this chain.

The chain may be used solely for moving the carriage, but need not also be used as a means for supplying power to the motor. For supplying power to the motor, the metal inserts inside the rail have considerably better conductive properties as compared to a chain.

According to yet another embodiment of the invention, openings are provided in one wall of the carriage through which the current collectors are guided, wherein the current collectors are positioned so as to be protected against destruction. That is to say, the current collectors embodied in this way are not sensitive to interfering influences and mechanical loads.

### BRIEF DESCRIPTION OF THE DRAWINGS

Embodiments of the invention are explained in the following with the aid of the drawings, which show in:

FIG. 1: A schematic representation of a gate with an associated drive system according to an embodiment of the invention;

FIG. 2a: The configuration for the drive system shown in FIG. 1;

FIG. 2b: A detailed representation of the arrangement according to FIG. 2a;

FIG. 2c: A view from the side of the arrangement according to FIG. 2a;

FIG. 3a: A cross-sectional representation of a rail with metal inserts for the drive system shown in FIGS. 1 and 2;

FIG. 3b: A view of the underside of the rail according to FIG. 3a;

FIG. 4: A representation of a carriage and a module which is positioned on the rail as shown in FIG. 3 and is provided with a limit switch actuator, according to an embodiment of the invention;

FIG. 5: A cross-sectional representation of a part of the carriage, as shown in FIG. 4, provided with an arrangement of current collectors; and

FIG. 6: A view from above of the arrangement according to FIG. 5.

### DETAILED DESCRIPTION

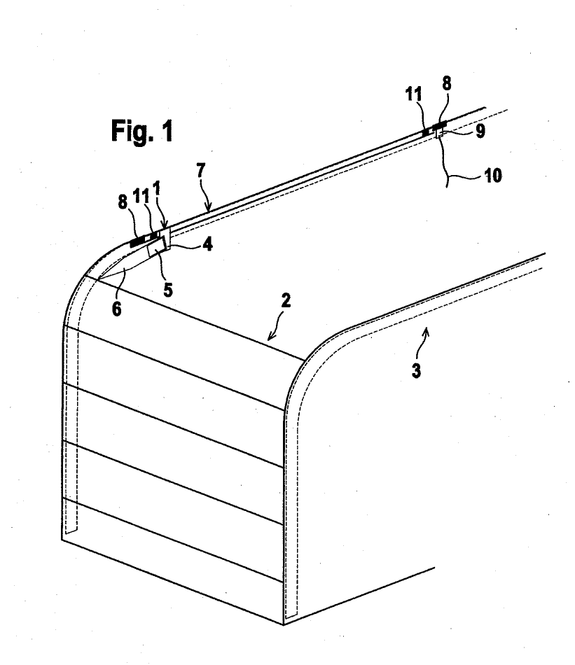

FIG. 1 schematically shows a drive system 1 for a door 2 according to an embodiment of the invention, which, for example, may be a garage door. The door 2, in the present case embodied as a sectional door, includes several individual sections or parts. In principle, the door 2 can also be embodied as a side sectional door, an all-around door, a tilt door, a swinging or up and over door, or as an overhead door.

The door 2 is guided along each of the two edges inside respective guide rails 3. Each guide rail 3 has a vertically extending rail segment and a horizontally extending rail segment, wherein the horizontal and the vertical rail segments are connected via a curved rail segment.

In FIG. 1, the door 2 is shown in a closed position in which the door 2 is arranged between the vertical rail segments of the guide rails 3, so as to close off a garage door opening which is not shown herein in further detail. In an opened position, the door 2 is arranged between the horizontal rail segments of the guide rails 3, which extend along the garage ceiling.

The door 2 can be moved between the closed position and the opened position with the aid of the drive system 1. FIG. 1 shows that the drive system 1 is installed on the left guide rail 3. However, the drive system 1 can optionally also be installed on the right guide rail 3.

The drive system 1 is provided with a carriage 4 which can traverse back and forth along the left guide rail 3 and is driven with the aid of a motor 5, embodied, for example, as an electric motor. The motor 5 is mounted on a push arm 6 which forms an articulated connection between the upper edge of the door 2 and the carriage 4. A rail 7, with therein disposed conductive tracks that are not shown in further detail in FIG. 1, is installed as an additional component of the drive system 1 in the region of the horizontal rail segment of the left guide rail 3. The conductive tracks function to supply power to the motor 5. Integrated for that purpose into the carriage 4 are suitable power collection means, not shown herein, which are in electrical contact with the conductive tracks and are connected to the motor 5.

The rail 7 is attached, in particular with screws, to the longitudinal side ends of the left guide rail 3 with the aid of holders which are not shown separately herein.

A contacting module 8 may be provided in the region of each longitudinal side end of the rail 7. The contacting modules 8 have identical designs, for example, and are fitted onto the rail 7, for example, clipped on. For the connection to a power source, a plug 9 with thereto attached cable 10 can optionally be inserted into one of the contacting modules 8, wherein the cable 1 can also be connected with a different plug to the control unit for the door drive. Since the plug 9 can optionally be inserted into the front contacting module 8, in the region of the door opening, or as shown in FIG. 1 into the contacting module 8 at the back end of the door, the length of the cable 10 can be kept short. Integrated into each contacting module 8 is a circuit board, not shown herein, which functions on the one hand as contacting means for the plug 9 and, on the other hand, is provided with electrical contacts for establishing a conducting connection to the conductive tracks of the rail 7.

Two end modules 11 which serve to preset the end positions for the carriage 4 are furthermore arranged displaceable on the rail 7. These end modules 11 are also fitted onto the rail 7, for example, clipped on.

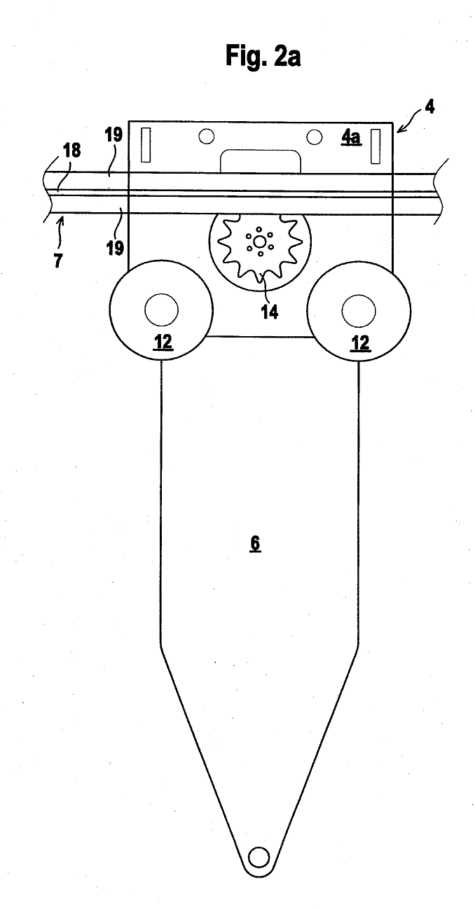

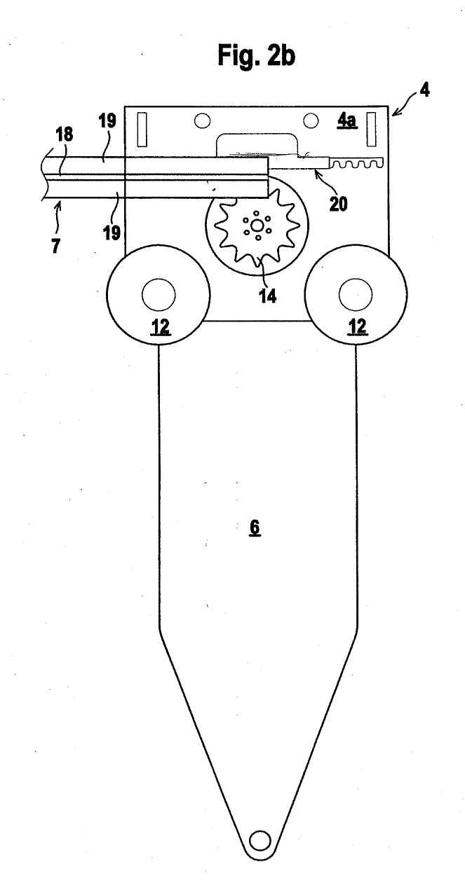

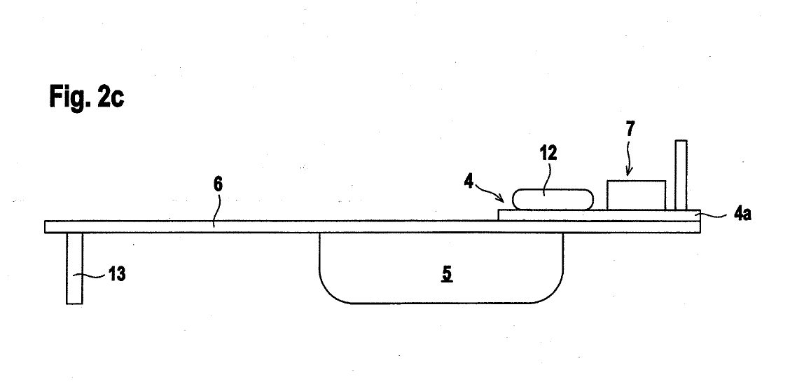

FIGS. 2a, 2b and 2c show detailed representations of components of the drive system 1, according to an embodiment. FIGS. 2a and 2b contain a detailed representation of the carriage 4 for the drive system 1, showing a view from above of a basic body 4a made of plastic, such as, for example, a glass-fiber reinforced plastic. FIG. 2c shows this arrangement in a view from the side. Two drive rollers 12 are positioned so as to rotate on this basic body 4a. The drive rollers 12 are configured to be guided inside the guide rails 3, wherein these drive rollers 12 can be adapted to differently designed guide rails 3.

The carriage 4 is connected articulated with the push arm 6 which, in turn, is connected to the door leaf. FIG. 2c shows the lower, exposed end of the push arm 6 which is provided with a peg 13 for the connection to the door leaf.

A chain wheel 14 is driven with the aid of the motor 5, arranged on the back side of the push arm 6. For this, the chain wheel 14 is mounted on the shaft of the motor 5.

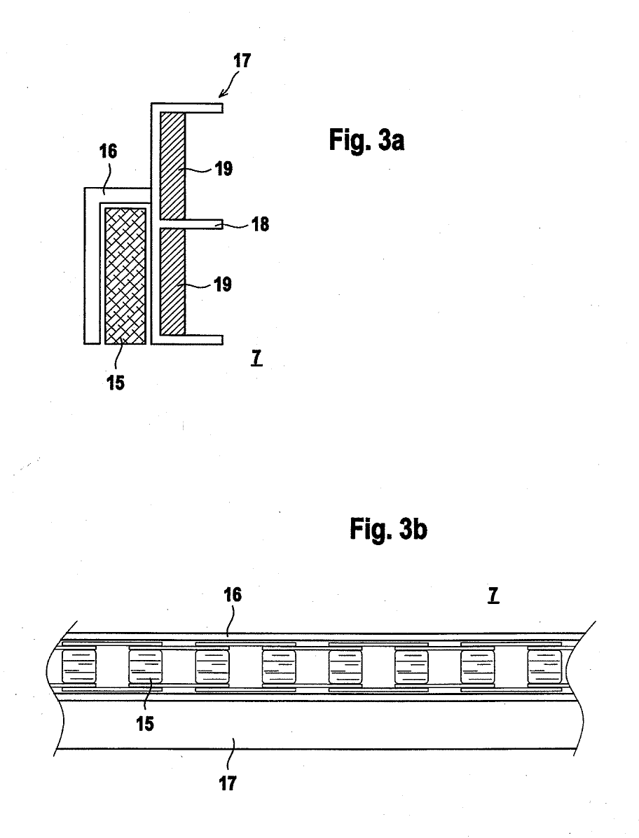

The chain wheel 14 engages in a chain 15 which is inserted as traction means into the rail 7 and is thus positioned locally fixed in the rail 7. FIGS. 3a and 3b show further details of the rail 7 and chain 15 integrated therein. The chain 15 is housed inside a chain channel 16 on the underside of the rail 7. The chain channel 16 on the underside of the rail 7 is open, thus making it possible for the chain wheel 14 to engage in the chain 15 via the open underside.

A shown in FIG. 3a, the front part of the rail 7 is embodied as a C-shaped profile 17. This profile 17 is embodied integrally with the chain channel 16 and is composed of an electrically insulating material such as, for example, a plastic material. A web 18 that is embodied integrally with the C-shaped profile 17 is provided in the center of the C-shaped profile 17. This web 18 divides the profile 17 into two segments, positioned one above the other, wherein respectively one metal insert 19 that forms a conductive track can be inserted into each of the segments. The metal inserts 19 are snapped, for example with clips, into the segments, wherein suitable undercuts that are not shown herein are provided for this in the walls of the C-shaped profile 17 and/or the web 18. As a result of the contacting modules 8, arranged on the ends of the rail 7, the metal inserts 19 are secured against being displaced in longitudinal direction of the rail 7, wherein the contacting modules 8 are provided with suitable end stops for this.

The motor 5 initiates the rotational movement of the chain wheel 14, so that the carriage 4 moves with its drive rollers 12, guided inside the left guide rail 3, along the left guide rail 3 and along the rail 7 attached thereto. The rail 7 in the process pushes against an end stop 20 (FIG. 2b) on the basic body 4a. Contrary to the basic body 4a, the end stop 20 is not composed of a glass-fiber reinforced plastic, but may include a plastic with sliding ability. The top of the chain channel 16 for the rail 7 fits against this end stop 20, thereby ensuring that forces generated within the carriage 4 do not leave the carriage 4.

As additional elements of the carriage 4, electronic components as well as a cover are fitted onto the basic body 4a of the carriage 4, as shown in FIGS. 2a to 2c.

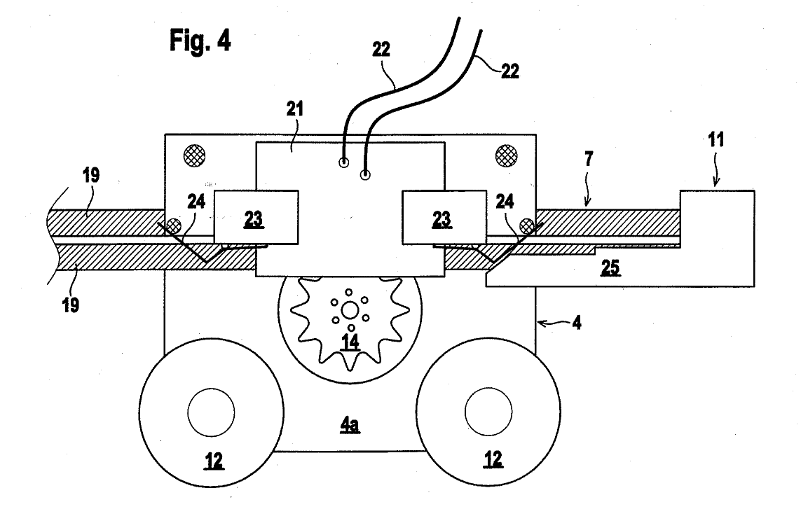

The basic body 4a of the carriage 4 is shown together with the electronic components in the embodiment depicted in FIG. 4. Provided is an electronic assembly, comprising a circuit board 21 from which connecting cables 22 extend which can be connected to the motor 5. Two limit switches 23 are furthermore also arranged on the circuit board 21, wherein each limit switch 23 is provided with a switching flag 24.

One of the end modules 11 which are arranged on the rail 7 is furthermore shown in the embodiment depicted in FIG. 4. The end module 11 is provided with an actuator having, for example, a cam 25 for the switching flag 24 of the right limit switch 23. If the carriage 4 moves toward the end module 11, the switching flag 24 comes in contact with the cam 25 of the actuator and is thus pushed upward, thereby causing the limit switch 23 to respond.

To preset the two limit positions, the end modules 11 are pushed along the rail 7 to the respective positions. If the carriage 4 subsequently collides with one of the end modules 11, the motor 5 is stopped as a result of a response of the limit switch 23 which, in turn, is caused by the activation of the switching flag 24 by the activator of the respective end module 11.

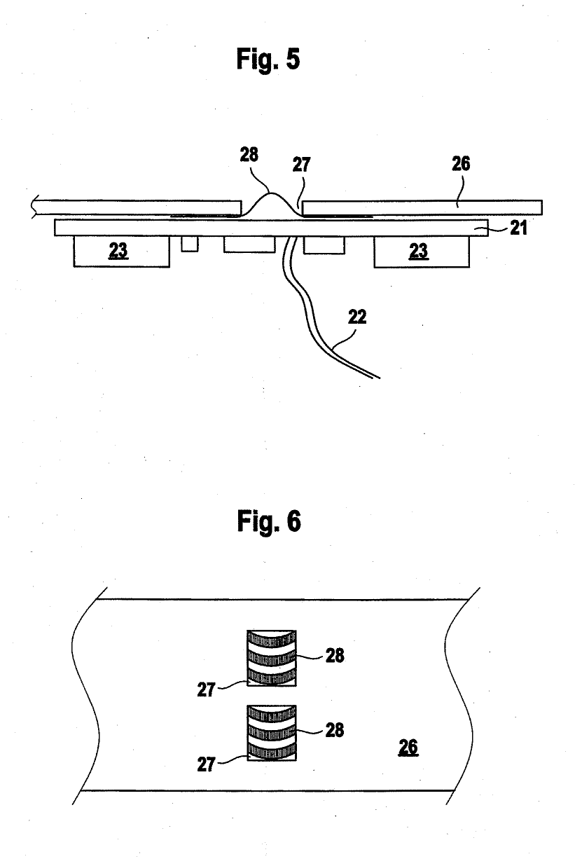

FIG. 5 shows a cross-sectional representation of the printed circuit board 21 with the limit switches 23, as well as a wall 26 that closes off the back side as a component of the covering for the electronic assembly. This wall 26 is facing the metal inserts 19, meaning the two conductive tracks in the rail 7. FIG. 6 shows a view from above of the wall 26.

Two rectangular openings 27 are provided in the wall 26. Projecting through each of the openings 27 is a current collector 28 which electrically contacts one of the conductive tracks (metal inserts 19) in the rail 7. The current collectors 28 may each include a metal strip. Each current collector 28 forms a bracket, wherein the back of a bracket projects over the opening 27 and can thus contact the associated conductive track. A carbon contacting element can alternatively be provided for the contacting. The exposed ends of these brackets are on the one hand in contact with the circuit board 21 while, on the other hand, the exposed ends of a bracket are respectively positioned on inside wall segments of the wall 26, wherein these segments are located on opposite edges of the opening 27. As a result of positioning the exposed ends against the two opposite-arranged edges of the opening 27, the back of the bracket is positioned rigid inside the respective opening 27 and is thus protected against mechanical damage.

Power is supplied to the motor 5 with the aid of the current collectors 28 which are guided along the conductive tracks. The conductive tracks are connected to a power source via the contacting module 8 and the plug 9 inserted therein. The current collectors 28, which slide along the conductive tracks during the movement of the carriage 4, supply power to the motor 5 which is connected via the connecting cables 22 to the circuit board 21 on which the current collectors 28 are arranged.

From the foregoing, it will be appreciated that although specific examples have been described herein for purposes of illustration, various modifications may be made without deviating from the spirit or scope of this disclosure. It is therefore intended that the foregoing detailed description be regarded as illustrative rather than limiting, and that it be understood that it is the following claims, including all equivalents, that are intended to particularly point out and distinctly claim the inventive subject matter.

1-16. (canceled)

17. A drive system for a door including a door leaf, each side of which is guided inside a respective guide rail, the drive system comprising:
a carriage configured to be coupled to an upper edge of the door leaf, wherein the carriage comprises a motor configured to drive the carriage along one of the guide rails; and
conductive tracks extending along the guide rail, wherein the conductive tracks are arranged to supply power to the motor, and wherein the conductive tracks are optionally contacted either on a front or a back end of the rail.

18. The drive system according to claim 17, further comprising a rail coupled to and extending along the guide rail, and wherein the rail includes two metal inserts forming the conductive tracks.

19. The drive system according to claim 18, wherein the rail has a C-shaped profile for accommodating the conductive tracks.

20. The drive system according to claim 18, wherein the metal inserts are separated mechanically and electrically by a web in the rail.

21. The drive system according to claim 18, further comprising a contacting module installed at an end of the rail and configured to establish electrical contact with the metal inserts.

22. The drive system according to claim 21, further comprising a plug optionally connected to the contacting module.

23. The drive system according to claim 18, further comprising end modules displaceably arranged on the rail, wherein each end module includes an actuator for actuating limit switches integrated in the carriage.

24. The drive system according to claim 18, further comprising a traction device integrated into the rail, along which the carriage is moved.

25. The drive system according to claim 24, wherein the traction device comprises a chain disposed in the rail, wherein a chain wheel driven by the motor engages in the chain.

26. The drive system according to claim 24, wherein the traction device comprises a toothed belt, a perforated belt, a ball chain, a rope, or a toothed rack arranged to be engaged by a drive element of the carriage.

27. The drive system according to claim 18, wherein the carriage comprises an end stop, wherein the rail is pressed against the end stop.

28. The drive system according to claim 17, wherein the carriage comprises current collectors arranged to establish contact with the conductive tracks.

29. The drive system according to claim 27, wherein a wall of the carriage includes openings through which the current collectors extend.

30. The drive system according to claim 29, wherein each current collector forms a bracket that projects through the opening, wherein the exposed ends of the bracket are attached on both sides of the opening to segments on the inside of the wall.

31. The drive system according to claim 17, wherein the carriage is optionally attached to one of the guide rails.

32. The drive system according to claim 17, wherein the conductive tracks extend along a segment of the guide rail that extends in a horizontal direction.

33. The drive system according to claim 27, wherein the end stop comprises a material having a sliding ability.

34. The drive system according to claim 17, wherein the carriage comprises an arm pivotably coupled to the door leaf.
